(19) United States
(12) Patent Application Publication
(10) Pub. No.: US 2024/0007950 A1
(43) Pub. Date: Jan. 4, 2024

(54) Connected-Mode Power Saving With A Low-Power Wake-Up Signal For A Dual-Radio System In Mobile Communications

(71) Applicant: MediaTek Inc., Hsinchu City (TW)

(72) Inventors: Yi-Ju Liao, Hsinchu City (TW); Chien-Chun Cheng, Hsinchu City (TW); Wei-De Wu, Hsinchu City (TW)

(21) Appl. No.: 18/205,506

(22) Filed: Jun. 3, 2023

Related U.S. Application Data
(60) Provisional application No. 63/367,634, filed on Jul. 4, 2022.

(51) Int. Cl. H04W 52/02

(52) U.S. Cl. CPC H04W 52/0229; H04W 52/0212

(57) ABSTRACT

Examples pertaining to connected-mode power saving with a low-power (LP) wake-up signal (WUS) for a dual-radio system in mobile communications are described. In one example, an apparatus may monitor, via a secondary radio of the apparatus, whether an LP WUS is received from a network node in a case that the apparatus is operating in a connected mode. The apparatus may determine whether to wake up a main radio of the apparatus for physical downlink control channel (PDCCH) monitoring in the connected mode based on the monitoring of the LP WUS.

### CROSS REFERENCE TO RELATED PATENT APPLICATION(S)

The present disclosure is part of a non-provisional application claiming the priority benefit of U.S. Patent Application No. 63/367,634, filed 4 Jul. 2022, the content of which herein being incorporated by reference in its entirety.

### TECHNICAL FIELD

The present disclosure is generally related to mobile communications and, more particularly, to connected-mode power saving with a low-power (LP) wake-up signal (WUS) for a dual-radio system in mobile communications.

### BACKGROUND

Unless otherwise indicated herein, approaches described in this section are not prior art to the claims listed below and are not admitted as prior art by inclusion in this section.

Power saving is one of the most important issues in any wireless communication system, and its importance is even more relevant for mobile devices, such as smartphones, which have limited amount of power source (e.g., battery) comparing to other type of devices, such as fixed wireless customer premise equipment (CPE) or devices mounted on a vehicle. This issue has become more important in 5^{th} Generation (5G) New Radio (NR) since it has been observed that mobile devices (and even the base stations) tend to consume power more quickly when they are operating in 5G NR than in other legacy technologies (e.g., Long-Term Evolution (LTE)).

To save power, a mobile device (or called a user equipment (UE)) may enter a radio resource control (RRC) idle or inactive mode when there is no data traffic, but the UE has to monitor whether the wireless network is sending any paging message to it and it has to spend some energy to run this “monitoring” process. In the RRC idle/inactive mode, the UE may stay in a sleep mode in a discontinuous reception (DRX) cycle. The UE may periodically wake up and monitor physical downlink control channel (PDCCH) in a DRX ON duration to check for the presence of a paging message. If the PDCCH indicates that a paging message is transmitted in a subframe, then the UE may demodulate the paging channel to see if the paging message is directed to it. Otherwise, the UE may stay in the sleep mode in a DRX OFF duration since the wireless network will not be transmitting any data to the UE in the DRX OFF duration.

In 3^{rd} Generation Partnership Project (3GPP) Release-16 for 5G NR, a wake-up signal (WUS) is introduced to enhance power saving in the RRC idle/inactive mode, by allowing the idle/inactive mode UE to only wake up in a DRX ON duration if a received WUS indicates the UE to wake up for the DRX ON duration. That is, the UE is allowed to skip a DRX ON duration if the received WUS indicates otherwise, so that the UE may stay in the sleep mode for a longer period of time. However, the R-16 WUS is generally used only for the purpose of data scheduling indication and is designed for UEs with a single-radio architecture. The single radio is generally a power-hungry transceiver that is capable of complicated radio frequency (RF) signal processing, such as modulation and demodulation, and the receiver area size of such radio may not suit for compact devices or small form-factor devices, such as Internet-of-Things (IoT) devices or wearable devices.

Therefore, a solution is sought to further improve the power saving issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to connected-mode power saving with a low-power (LP) wake-up signal (WUS) for a dual-radio system in mobile communications.

In one aspect, a method may involve an apparatus monitoring, via a secondary radio of the apparatus, whether an LP WUS is received from a network node in a case that the apparatus is operating in a connected mode. The method may also involve the apparatus determining whether to wake up a main radio of the apparatus for physical downlink control channel (PDCCH) monitoring in the connected mode based on the monitoring of the LP WUS.

In one aspect, an apparatus may comprise a transceiver which, during operation, wirelessly communicates with a network node of a wireless network, wherein the transceiver comprises a main radio and a secondary radio. The apparatus may also comprise a processor communicatively coupled to the transceiver. The processor, during operation, may perform operations comprising monitoring, via the secondary radio, whether an LP WUS is received from the network node in a case that the apparatus is operating in a connected mode; and determining whether to wake up the main radio for PDCCH monitoring in the connected mode based on the monitoring of the LP WUS.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (I) and Narrow Band Internet of Things (NB-IoT), Industrial Internet of Things (IoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example dual-radio system under schemes in accordance with implementations of the present disclosure.

FIG. 2 is a diagram depicting an example scenario with an LP WUS under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to connected-mode power saving with a low-power (LP) wake-up signal (WUS) for a dual-radio system in mobile communications. According to the present disclosure, a number of possible solutions may be implemented separately or jointly. That is, although these possible solutions may be described below separately, two or more of these possible solutions may be implemented in one combination or another.

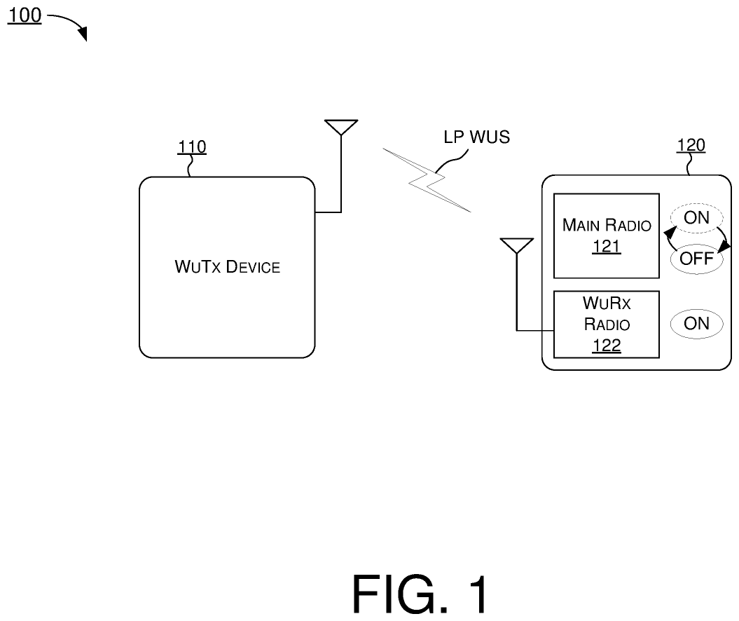

FIG. 1 illustrates an example dual-radio system 100 having a WuTx device 110 and a dual-radio device 120 in accordance with implementations of the present disclosure. The WuTx device 110 may be implemented in a gNB or a Transmission or Reception Point (TRP), and may send an LP WUS to the WuRx radio 122 of the dual-radio device 120. The dual-radio device 120 may be implemented in a UE. The dual-radio device 120 includes a main radio 121 for handling synchronization signal block (SSB)/tracking reference signal (TRS) reception, PDCCH monitoring/decoding, and higher-layer signaling, etc., and a WuRx radio 122 for handling LP WUS monitoring. In some implementations, the main radio 121 is a high-power transceiver with a larger receiver area size, while the WuRx radio 122 is a low-power receiver with a smaller receiver area size. In some implementations, the LP WUS is a narrowband signal which includes only one or few resource blocks in frequency domain.

It is noteworthy that the main radio 121 may stay in a sleep mode (e.g., turned off or operating in a low-power mode or deep sleep mode) by default, while the WuRx radio 122 may always stay in an active mode (e.g., turned on) for LP WUS monitoring and determine whether to wake up (i.e., turns on) the main radio 121 for PDCCH monitoring based on the result of the LP WUS monitoring. Furthermore, the LP WUS may be associated with specific PDCCH monitoring, e.g., PDCCH within an active bandwidth part (BWP), PDCCH of a specific control resource set (CORSET), PDCCH for a specific downlink control information (DCI) format (i.e., PDCCH scrambled with a specific radio network temporary identifier (RNTI) type), PDCCH of a specific search space, or PDCCH of a specific search space set group (SSSG). In some implementations, the LP-WUS may indicate whether to monitor (or skip) the associated PDCCH monitoring. For example, the WuRx radio 122 may determine to wake up the main radio 121 if an LP WUS is detected/received or if a detected/received LP WUS indicates to wake up the main radio 121. Otherwise, if an LP WUS is not detected/received or if a detected/received LP WUS indicates not to wake up the main radio 121, the WuRx radio 122 may determine not to wake up the main radio 121. In some implementations, the presence/absence of LP-WUS may indicate whether to monitor (or skip) the associated PDCCH monitoring, and whether to wake up the main radio 121 if an LP WUS is not detected/received may depend on higher layer signaling, i.e., there may be a higher layer signaling to indicate UE behavior in this case.

In addition, the dual-radio device 120 may receive, e.g., via the main radio 121, configuration of the LP WUS from a network node (e.g., a gNB or TRP). The configuration of the LP WUS may include at least one or a set of the following information: (1) frequency resource information of the LP WUS; (2) a monitoring periodicity of the LP WUS; (3) information indicating an association between the LP WUS and the PDCCH monitoring; and (4) a time offset between the LP WUS and the PDCCH monitoring. In some implementations, the configuration of the LP WUS may be received in a higher layer signaling (e.g., a user equipment (UE)-specific radio resource control (RRC) signaling).

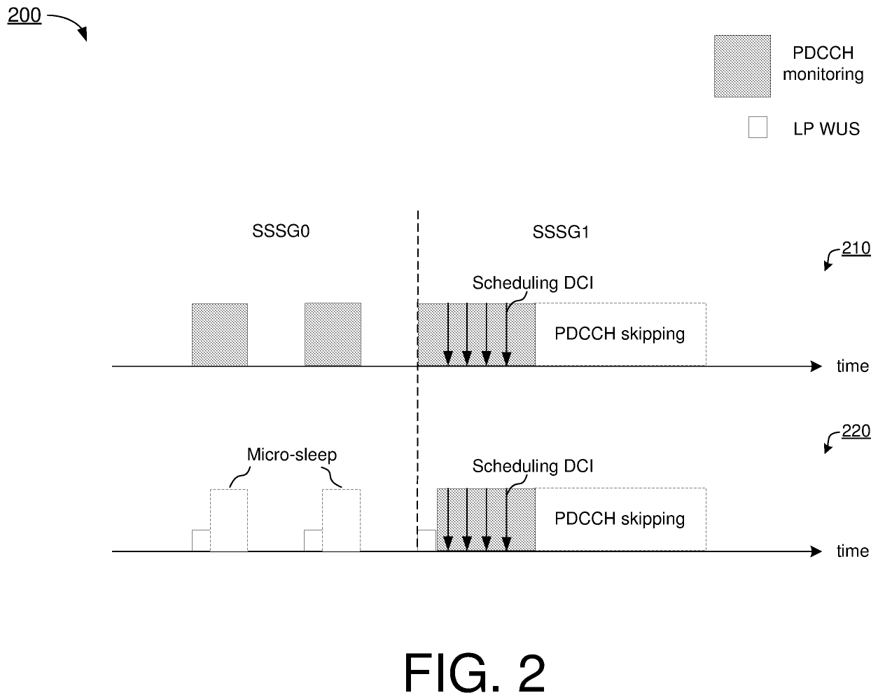

FIG. 2 illustrates an example scenario 200 with an LP WUS under schemes in accordance with implementations of the present disclosure. Scenario 200 illustrates the concept of applying LP WUS for enhanced power saving in the RRC connected mode (e.g., for frequent traffic scenarios, such as Extended Reality (XR) scenarios). Diagram 210 depicts SSSG switching and PDCCH skipping in R-17 (without LP WUS) for a single-radio UE, where SSSG0 and SSSG1 are associated with two-slot PDCCH monitoring and per-slot PDCCH monitoring, respectively, and PDCCH skipping is indicated by scheduling DCI. In diagram 210, the single radio needs to remain awake for PDCCH monitoring of the associated SSSG, unless it is instructed to skip PDCCH monitoring by scheduling DCI. Diagram 220 depicts SSSG switching and PDCCH skipping with LP WUS for a dual-radio UE, where LP-WUS is introduced to indicate whether to monitor PDCCH of SSSG0/SSSG1. In diagram 220, if an LP WUS indicates not to wake up the main radio, the UE may skip PDCCH monitoring of SSSG0/SSSG1, i.e., not wake up the main radio. Otherwise, if an LP WUS indicates to wake up the main radio, the UE may wake up the main radio for PDCCH monitoring of SSSG0/SSSG1. In some implementations, due to required time to wake up the main radio, it may be feasible for the main radio to stay only in micro-sleep when the LP WUS indicates not to wake up.

In view of the above, the present disclosure proposes schemes pertaining to connected-mode power saving with an LP WUS for a dual-radio system in mobile communications. According to the schemes of the present disclosure, a secondary radio is introduced to handle LP WUS monitoring, such that the power-hungry main radio is allowed to stay in the sleep mode longer. By applying the schemes of the present disclosure, further power saving may be realized by reducing the wake-up energy overhead of the main radio. Specifically, the LP WUS may be used as an indication of whether to wake up the main radio for PDCCH monitoring in the RRC connected mode.

### Illustrative Implementations

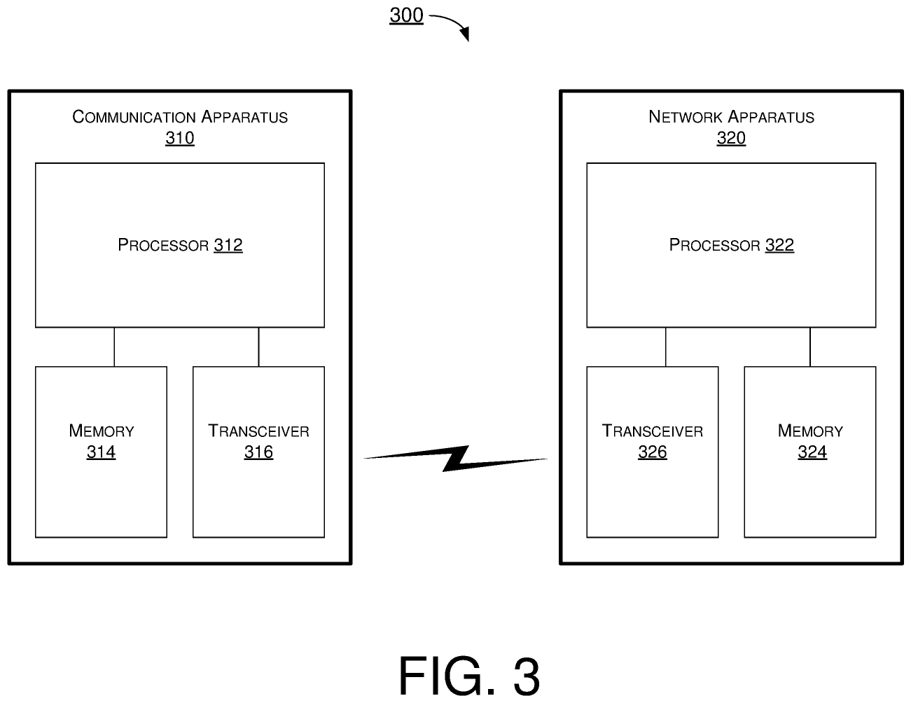

FIG. 3 illustrates an example communication system 300 having an example apparatus 310 and an example apparatus 320 in accordance with an implementation of the present disclosure. Each of apparatus 310 and apparatus 320 may perform various functions to implement schemes, techniques, processes and methods described herein pertaining to connected-mode power saving with an LP WUS for a dual-radio system in mobile communications, including scenarios/schemes described above as well as process 400 described below.

Apparatus 310 may be a part of an electronic apparatus, which may be a UE, such as a portable or mobile apparatus, a wearable apparatus, a wireless communication apparatus or a computing apparatus, with a dual-radio architecture. For instance, apparatus 310 may be implemented in a smartphone, a smartwatch, a personal digital assistant, a digital camera, or a computing equipment such as a tablet computer, a laptop computer or a notebook computer. Apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, apparatus 310 may be implemented in a smart thermostat, a smart fridge, a smart door lock, a wireless speaker or a home control center. Alternatively, apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 310 may include at least some of those components shown in FIG. 3 such as a processor 312, for example. Apparatus 310 may further include one or more other components not pertinent to the proposed scheme of the present disclosure (e.g., internal power supply, display device and/or user interface device), and, thus, such component(s) of apparatus 310 are neither shown in FIG. 3 nor described below in the interest of simplicity and brevity.

Apparatus 320 may be a part of an electronic apparatus, which may be a network node, such as a base station, a small cell, a router or a gateway. For instance, apparatus 320 may be implemented in an eNodeB in an LTE, LTE-Advanced or LTE-Advanced Pro network or in a gNB/TRP in a 5G, NR, IoT, NB-IoT or IIoT network. Alternatively, apparatus 320 may be implemented in the form of one or more IC chips such as, for example and without limitation, one or more single-core processors, one or more multi-core processors, or one or more RISC or CISC processors. Apparatus 320 may include at least some of those components shown in FIG. 3 such as a processor 322, for example. Apparatus 320 may further include one or more other components not pertinent to the proposed scheme of the present disclosure (e.g., internal power supply, display device and/or user interface device), and, thus, such component(s) of apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to connected-mode power saving with an LP WUS for a dual-radio system in mobile communications in accordance with various implementations of the present disclosure.

In some implementations, apparatus 310 may also include a transceiver 316 coupled to processor 312 and capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 314 and memory 324 may include a universal integrated circuit card (UICC).

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., dual-radio device 120), and apparatus 320, as a network node (e.g., WuTx device 110), is provided below.

Under certain proposed schemes in accordance with the present disclosure with respect to connected-mode power saving with an LP WUS for a dual-radio system in mobile communications, processor 312 of apparatus 310, implemented in or as a UE, may monitor, via a secondary radio (e.g., WuRx radio 122) of the transceiver 316, whether an LP WUS is received from network apparatus 520 in a case that the apparatus is operating in a connected mode (e.g., RRC connected mode). Additionally, processor 312 may determine whether to wake up a main radio (e.g., main radio 121) of the transceiver 316 for PDCCH monitoring in the connected mode based on the monitoring of the LP WUS.

In some implementations, processor 312 may also receive, via the main radio, a first configuration from the network node. The first configuration may include at least one of the following: (1) frequency resource information of the LP WUS; (2) a monitoring periodicity of the LP WUS; (3) information indicating an association between the LP WUS and the PDCCH monitoring; and (4) a time offset between the LP WUS and the PDCCH monitoring.

In some implementations, the PDCCH monitoring may be performed for one of the following: (1) PDCCH within an active BWP; (2) PDCCH of a specific CORSET; (3) PDCCH for a specific DCI format (i.e., PDCCH scrambled with a specific RNTI type); (4) PDCCH of a specific search space; and (5) PDCCH of a specific SSSG.

In some implementations, the first configuration may be received in a UE-specific RRC signaling.

In some implementations, the determination of whether to wake up the main radio may include: processor 312 determining to wake up the main radio for PDCCH monitoring in the connected mode in a case that the LP WUS is received; and processor 312 determining not to wake up the main radio for PDCCH monitoring in the connected mode in a case that the LP WUS is not received.

In some implementations, the determination of whether to wake up the main radio may include: processor 312 determining to wake up the main radio for PDCCH monitoring in the connected mode in a case that the LP WUS is received and indicates to wake up the main radio; and processor 312 determining not to wake up the main radio for PDCCH monitoring in the connected mode in a case that the LP WUS is received and indicates not to wake up the main radio. Additionally, the determination of whether to wake up the main radio may include: processor 312 determining not to wake up the main radio for PDCCH monitoring in the connected mode in a case that the LP WUS is not received; or alternatively, processor 312 may also receive, via the main radio, a second configuration from the network node. The second configuration may indicate whether or not to wake up the main radio for PDCCH monitoring in the connected mode in the case that the LP WUS is not received.

In some implementations, the LP WUS may include a narrowband signal comprising only one or few resource blocks in frequency domain.

In some implementations, the LP WUS may be transmitted in a repetition manner in time domain, to enhance the coverage of the LP WUS.

In some implementations, for multiplexing of LP-WUS and legacy UE, the network node may avoid resource collision by scheduling.

### Illustrative Processes

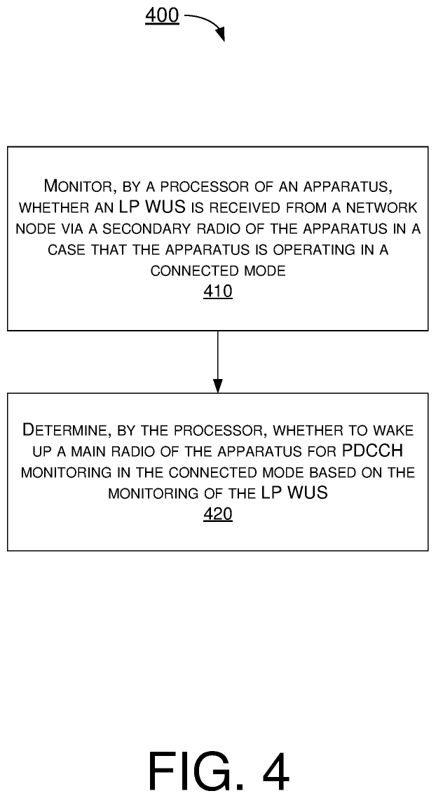

FIG. 4 illustrates an example process 400 in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to connected-mode power saving with an LP WUS for a dual-radio system in mobile communications. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 310 as well as any variations thereof. Solely for illustrative purposes and without limiting the scope, process 400 is described below in the context of apparatus 310 as a UE (e.g., dual-radio device 120). Process 400 may begin at block 410.

At 410, process 400 may involve processor 312 of apparatus 310, implemented in or as a UE, monitoring, via a secondary radio (e.g., WuRx radio 122) of apparatus 310, whether an LP WUS is received from a network node (e.g., apparatus 320) in a case that apparatus 310 is operating in a connected mode (e.g., RRC connected mode). Process 400 may proceed from 410 to 420.

At 420, process 400 may involve processor 312 determining whether to wake up a main radio (e.g., main radio 121) of apparatus 310 for PDCCH monitoring in the connected mode based on the monitoring of the LP WUS.

In some implementations, process 400 may further involve processor 312 receiving, via the main radio, a first configuration from the network node. The first configuration may include at least one of the following: (1) frequency resource information of the LP WUS; (2) a monitoring periodicity of the LP WUS; (3) information indicating an association between the LP WUS and the PDCCH monitoring; and (4) a time offset between the LP WUS and the PDCCH monitoring.

In some implementations, the PDCCH monitoring may be performed for one of the following: (1) PDCCH within an active BWP; (2) PDCCH of a specific CORSET; (3) PDCCH for a specific DCI format (i.e., PDCCH scrambled with a specific RNTI type); (4) PDCCH of a specific search space; and (5) PDCCH of a specific SSSG.

In some implementations, the first configuration may be received in a UE-specific RRC signaling.

In some implementations, the determination of whether to wake up the main radio may include: processor 312 determining to wake up the main radio for PDCCH monitoring in the connected mode in a case that the LP WUS is received; and processor 312 determining not to wake up the main radio for PDCCH monitoring in the connected mode in a case that the LP WUS is not received.

In some implementations, the determination of whether to wake up the main radio may include: processor 312 determining to wake up the main radio for PDCCH monitoring in the connected mode in a case that the LP WUS is received and indicates to wake up the main radio; and processor 312 determining not to wake up the main radio for PDCCH monitoring in the connected mode in a case that the LP WUS is received and indicates not to wake up the main radio. Additionally, the determination of whether to wake up the main radio may include: processor 312 determining not to wake up the main radio for PDCCH monitoring in the connected mode in a case that the LP WUS is not received; or alternatively, process 400 may further involve processor 312 receiving, via the main radio, a second configuration from the network node. The second configuration may indicate whether or not to wake up the main radio for PDCCH monitoring in the connected mode in the case that the LP WUS is not received.

In some implementations, the LP WUS may include a narrowband signal comprising only one or few resource blocks in frequency domain.

In some implementations, the LP WUS may be transmitted in a repetition manner in time domain, to enhance the coverage of the LP WUS.

In some implementations, for multiplexing of LP-WUS and legacy UE, the network node may avoid resource collision by scheduling.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
monitoring, by a processor of an apparatus, whether a low-power (LP) wake-up signal (WUS) is received from a network node via a secondary radio of the apparatus in a case that the apparatus is operating in a connected mode; and
determining, by the processor, whether to wake up a main radio of the apparatus for physical downlink control channel (PDCCH) monitoring in the connected mode based on the monitoring of the LP WUS.

2. The method of claim 1, further comprising:
receiving, by the processor, a first configuration from the network node via the main radio, wherein the first configuration comprises at least one of the following:
frequency resource information of the LP WUS;
a monitoring periodicity of the LP WUS;
information indicating an association between the LP WUS and the PDCCH monitoring; and
a time offset between the LP WUS and the PDCCH monitoring.

3. The method of claim 2, wherein the PDCCH monitoring is performed for one of the following:
a PDCCH within an active bandwidth part (BWP);
a PDCCH of a specific control resource set (CORESET);
a PDCCH for a specific downlink control information (DCI) format;
a PDCCH of a specific search space; and
a PDCCH of a specific search space set group (SSSG).

4. The method of claim 2, wherein the first configuration is received in a user equipment (UE)-specific radio resource control (RRC) signaling.

5. The method of claim 1, wherein the determination of whether to wake up the main radio comprises:
determining, by the processor, to wake up the main radio for PDCCH monitoring in the connected mode in a case that the LP WUS is received; and
determining, by the processor, not to wake up the main radio for PDCCH monitoring in the connected mode in a case that the LP WUS is not received.

6. The method of claim 1, wherein the determination of whether to wake up the main radio comprises:
determining, by the processor, to wake up the main radio for PDCCH monitoring in the connected mode in a case that the LP WUS is received and indicates to wake up the main radio; and
determining, by the processor, not to wake up the main radio for PDCCH monitoring in the connected mode in a case that the LP WUS is received and indicates not to wake up the main radio.

7. The method of claim 6, wherein the determination of whether to wake up the main radio comprises:
determining, by the processor, not to wake up the main radio for PDCCH monitoring in the connected mode in a case that the LP WUS is not received.

8. The method of claim 6, further comprising:
receiving, by the processor, a second configuration from the network node via the main radio, wherein the second configuration indicates whether or not to wake up the main radio for PDCCH monitoring in the connected mode in the case that the LP WUS is not received.

9. The method of claim 1, wherein the LP WUS comprises a narrowband signal comprising only one or few resource blocks in frequency domain.

10. The method of claim 1, wherein the LP WUS is transmitted in a repetition manner in time domain.

11. An apparatus, comprising:
a transceiver which, during operation, wirelessly communicates with a network node of a wireless network, wherein the transceiver comprises a main radio and a secondary radio; and
a processor communicatively coupled to the transceiver such that, during operation, the processor performs operations comprising:
monitoring, via the secondary radio, whether a low-power (LP) wake-up signal (WUS) is received from the network node in a case that the apparatus is operating in a connected mode; and
determining whether to wake up the main radio for physical downlink control channel (PDCCH) monitoring in the connected mode based on the monitoring of the LP WUS.

12. The apparatus of claim 11, wherein, during operation, the processor further performs operations comprising:
receiving, via the main radio, a first configuration from the network node, wherein the first configuration comprises at least one of the following:
frequency resource information of the LP WUS;
a monitoring periodicity of the LP WUS;
information indicating an association between the LP WUS and the PDCCH monitoring; and
a time offset between the LP WUS and the PDCCH monitoring.

13. The apparatus of claim 12, wherein the PDCCH monitoring is performed for one of the following:
a PDCCH within an active bandwidth part (BWP);
a PDCCH of a specific control resource set (CORESET);
a PDCCH for a specific downlink control information (DCI) format;
a PDCCH of a specific search space; and
a PDCCH of a specific search space set group (SSSG).

14. The apparatus of claim 12, wherein the first configuration is received in a user equipment (UE)-specific radio resource control (RRC) signaling.

15. The apparatus of claim 11, wherein the determination of whether to wake up the main radio comprises:
determining to wake up the main radio for PDCCH monitoring in the connected mode in a case that the LP WUS is received; and
determining not to wake up the main radio for PDCCH monitoring in the connected mode in a case that the LP WUS is not received.

16. The apparatus of claim 11, wherein the determination of whether to wake up the main radio comprises:
determining to wake up the main radio for PDCCH monitoring in the connected mode in a case that the LP WUS is received and indicates to wake up the main radio; and
determining not to wake up the main radio for PDCCH monitoring in the connected mode in a case that the LP WUS is received and indicates not to wake up the main radio.

17. The apparatus of claim 16, wherein the determination of whether to wake up the main radio comprises:
determining not to wake up the main radio for PDCCH monitoring in the connected mode in a case that the LP WUS is not received.

18. The apparatus of claim 16, wherein, during operation, the processor further performs operations comprising:
receiving, via the main radio, a second configuration from the network node, wherein the second configuration indicates whether or not to wake up the main radio for PDCCH monitoring in the connected mode in the case that the LP WUS is not received.

19. The apparatus of claim 11, wherein the LP WUS comprises a narrowband signal comprising only one or few resource blocks in frequency domain.

20. The apparatus of claim 11, wherein the LP WUS is transmitted in a repetition manner in time domain.
